(19) United States
(12) Patent Application Publication
(10) Pub. No.: US 2025/0096470 A1
(43) Pub. Date: Mar. 20, 2025

(54) ELECTRONIC DEVICE

(71) Applicant: PEGATRON CORPORATION, TAIPEI CITY (TW)

(72) Inventors: Chang-Hsun Wu, Taipei City (TW); Ming-Huang Chen, Taipei City (TW); Yu-Peng Lin, Taipei City (TW); Hung-Cheng Tsai, Taipei City (TW); Kuo-Yung Chiu, Taipei City (TW); Hsuan-Chi Lin, Taipei City (TW); Chao-Hsu Wu, Taipei City (TW)

(73) Assignee: PEGATRON CORPORATION, TAIPEI CITY (TW)

(21) Appl. No.: 18/762,177

(22) Filed: Jul. 2, 2024

(30) Foreign Application Priority Data
Sep. 19, 2023 (TW) 112135682

(51) Int. Cl. H01Q 9/04

(52) U.S. Cl. CPC H01Q 9/0421

(57) ABSTRACT

An electronic device includes a casing, an antenna, and a connector. The casing includes a metal layer and a first slot and a second slot located on the metal layer. The metal layer includes a metal connecting segment, a first region, and a second region. The metal connecting segment is located between the first slot and the second slot, and the first region and the second region are separated by the first slot, the second slot, and the metal connecting segment. The antenna is connected to the first region, and the antenna is adapted to resonate at a frequency band. The connector is connected to the second region.

### CROSS-REFERENCE TO RELATED APPLICATION

This application claims the priority benefit of Taiwan application serial no. 112135682, filed on Sep. 19, 2023. The entirety of the above-mentioned patent application is hereby incorporated by reference herein and made a part of this specification.

### BACKGROUND

### Technical Field

The disclosure relates to an electronic device, and in particular to an electronic device that can reduce interference of an antenna caused by noise of a connector.

### Description of Related Art

When a conventional notebook computer accesses data from an external storage device through a connector, the noise of the connector interferes with the wireless transmission performance of the antenna. The prior art reduces the interference of the antenna caused by the noise by arranging a metal shield around or attaching a composite material to the connector. However, the manner of attaching the composite material is prone to issues caused by unstable attachment or short circuit. Therefore, how to stably and effectively reduce the interference of the antenna caused by the noise of the connector is a direction to be explored in the art.

### SUMMARY

The disclosure provides an electronic device that can reduce interference of an antenna caused by noise of a connector.

An electronic device of the disclosure includes a casing, an antenna, and a connector. The casing includes a metal layer and a first slot and a second slot located on the metal layer. The metal layer includes a metal connecting segment, a first region, and a second region. The metal connecting segment located between the first slot and the second slot. The first region and the second region are separated by the first slot, the second slot, and the metal connecting segment. The antenna is connected to the first region, and the antenna is adapted to resonate at a frequency band. The connector is connected to the second region.

Based on the above, in the electronic device of the disclosure, the antenna is connected to the first region and the connector is connected to the second region to reduce the interference of the antenna caused by the noise of the connector, thereby improving the transmission distance and the wireless communication quality of the antenna.

### BRIEF DESCRIPTION OF THE DRAWINGS

FIG. 1A is a schematic top view of an electronic device according to an embodiment of the disclosure.

FIG. 1B is a schematic top view of an electronic device according to yet another embodiment of the disclosure.

FIG. 2 is a schematic top view of an electronic device according to another embodiment of the disclosure.

FIG. 3 is a partial cross-sectional side view of the electronic device of FIG. 2 along a line segment A-A.

FIG. 4 is a frequency-receiving sensitivity relationship diagram of a main antenna of the electronic device of FIG. 1A and FIG. 2.

FIG. 5 is a frequency-receiving sensitivity relationship diagram of an auxiliary antenna of the electronic device of FIG. 1A and FIG. 2.

FIG. 6 is a transmission distance-data transmission rate relationship diagram of the electronic device of FIG. 1A and FIG. 2.

FIG. 7 is a frequency-receiving sensitivity relationship diagram of the electronic device of FIG. 1A and FIG. 2.

### DESCRIPTION OF THE EMBODIMENTS

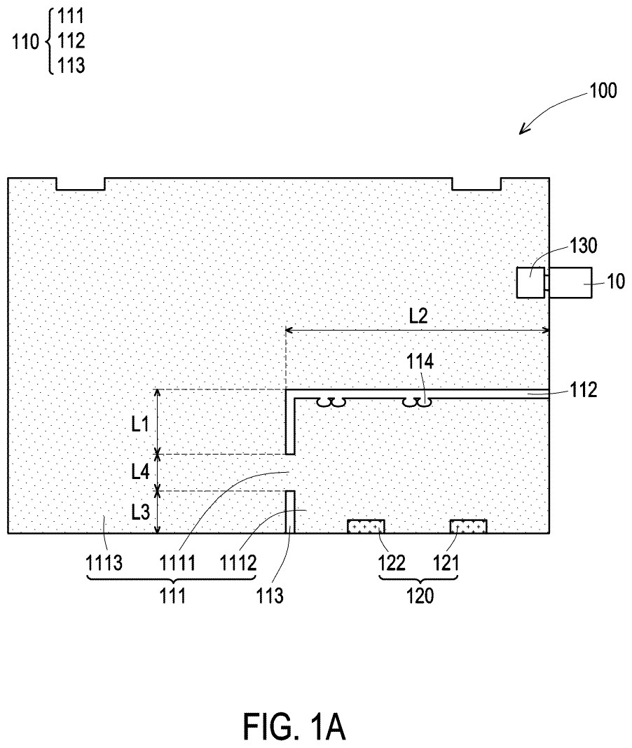

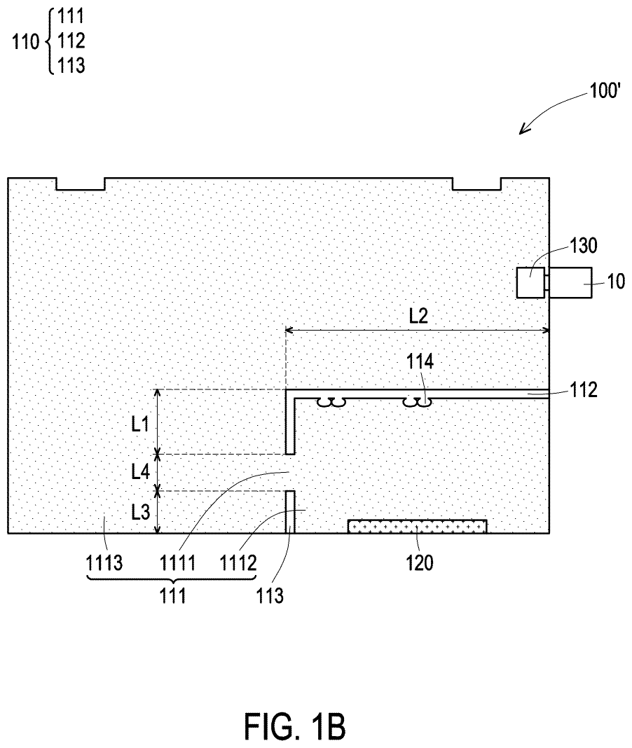

FIG. 1A is a schematic top view of an electronic device according to an embodiment of the disclosure. Please refer to FIG. 1A. An electronic device 100 of the disclosure is, for example, a notebook computer or a tablet computer. The electronic device 100 includes a casing 110, an antenna 120, and a connector 130. The casing 110 is, for example, an upper cover (part A) or a lower cover (part D) of the notebook computer or a back cover of the tablet computer. The casing 110 includes a metal layer 111 and a first slot 112 and a second slot 113 located on the metal layer 111. The metal layer 111 includes a metal connecting segment 1111 located between the first slot 112 and the second slot 113 and a first region 1112 and a second region 1113 separated by the first slot 112, the second slot 113, and the metal connecting segment 1111. The antenna 120 is connected to the first region 1112, and the antenna 120 is adapted to resonate at a frequency band. In the embodiment, the antenna 120 includes a main antenna 121 on the right and an auxiliary antenna 122 on the left. The connector 130 is, for example, USB 3.1 Type A, but not limited thereto. The connector 130 is connected to the second region 1113 and may be connected to an external storage device 10.

In addition, in the embodiment, the antenna 120 is adapted to resonate at a low-frequency band of Wi-Fi 6E, that is, 2400 to 2500 MHz, but the frequency band in which the antenna 120 resonates is not limited thereto. In other embodiments, the antenna 120 may also resonate at a low-frequency band of WWAN 5G Sub 6, that is, 617 to 960 MHz.

It is worth mentioning that in the electronic device 100, flow of direct current in the first region 1112 and the second region 1113 is blocked due to the first slot 112 and the second slot 113 between the first region 1112 and the second region 1113. Therefore, the metal connecting segment 1111 is added, so that the first region 1112 and the second region 1113 have the same direct current level, thereby providing a signal return current path to prevent a return signal from passing through the first slot 112 and the second slot 113 and causing signal discontinuity. Therefore, when the antenna 120 and the connector 130 are respectively disposed in the first region 1112 and the second region 1113 of the metal layer 111, noise generated by the connector 130 is blocked by the first slot 112 and the second slot 113, so that the frequency band in which the antenna 120 resonates is not interfered by the noise of the connector 130, thereby improving the wireless transmission performance of the antenna 120.

In the embodiment, the metal layer 111 is formed on the casing 110 by sputter deposition or coating, and the first slot 112 and the second slot 113 are located on the metal layer 111 by mask spray, but the manufacturing manners of the metal layer 111 and the first slot 112 and the second slot 113 are not limited thereto. In addition, in the electronic device 100, the metal layer 111 is formed through sputter deposition or coating to prevent unstable attachment of a composite material in the prior art, thereby improving the wireless transmission performance of the electronic device 100.

Please continue to refer to FIG. 1A. A length L4 of the metal connecting segment 1111 is between 0.2 times and 0.3 times the wavelength of the frequency band. The length of the first slot 112, that is, the total length of the length L1 plus the length L2, is between 1.5 times and 2 times the wavelength of the frequency band. A length L3 of the second slot 113 is between 0.15 times and 0.25 times the wavelength of the frequency band.

It is worth mentioning that in the electronic device 100, the length L4 of the metal connecting segment 1111 is between 0.2 times and 0.3 times the wavelength of the frequency band to suppress signal interference of the Wi-Fi 6E low frequency or the WWAN 5G Sub 6 low frequency generated by the antenna 120 caused by the noise of the connector 130.

In the embodiment, the length L4 of the metal connecting segment 1111 is 30 mm, but the length L4 of the metal connecting segment 1111 is not limited thereto. In addition, in the embodiment, the first slot 112 is L-shaped, but the shape of the first slot 112 is not limited thereto. In other embodiments, the first slot 112 may also be arc-shaped.

Please continue to refer to FIG. 1A. The casing 110 further includes a via 114 located on the metal layer 111. In the embodiment, the via 114 is connected to the first slot 112, but the position of the via 114 is not limited thereto. In other embodiments, the via 114 may also be connected to the second slot 113. In addition, in the embodiment, the vias 114 are four circular holes with a diameter of 5 mm, but the number, the shapes, and the sizes of the vias 114 are not limited thereto.

It is worth mentioning that in the electronic device 100, the vias 114 are disposed in the first slot 112 or/and the second slot 113 for point discharge purposes to improve the electrostatic discharge (ESD) protection effect of the electronic device 100.

FIG. 1B is a schematic top view of an electronic device according to yet another embodiment of the disclosure. The difference between an electronic device 100′ of FIG. 1B and the electronic device 100 of FIG. 1A is that the antenna 120 of the electronic device 100′ is a single antenna.

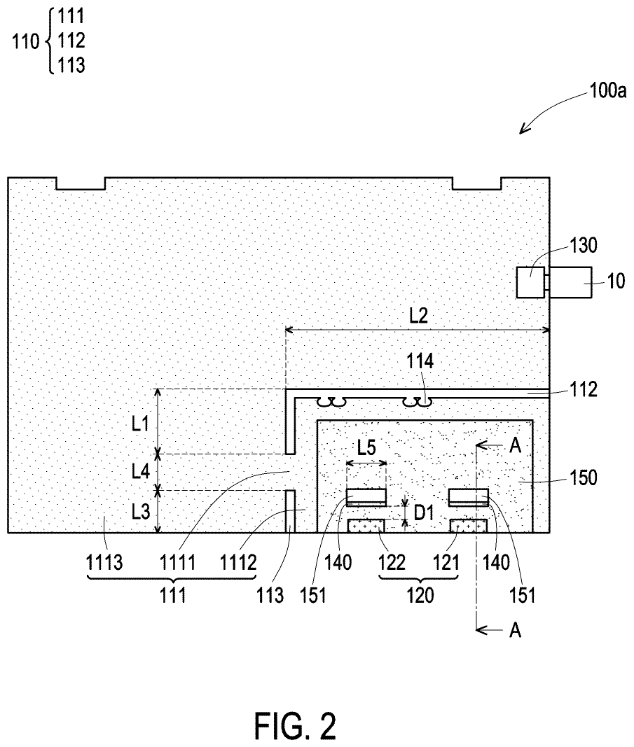

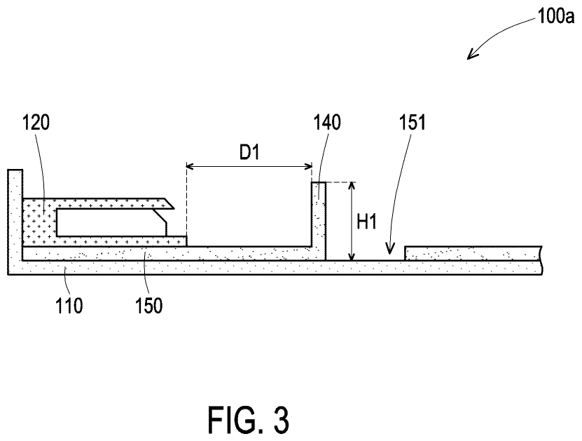

FIG. 2 is a schematic top view of an electronic device according to another embodiment of the disclosure. FIG. 3 is a partial cross-sectional side view of the electronic device of FIG. 2 along a line segment A-A. It should be noted that the main difference between an electronic device 100a of FIG. 2 and the electronic device 100 of FIG. 1A is that the electronic device 100a of FIG. 2 includes a metal retaining wall 140 and an inner metal member 150. The difference will be described below.

Please refer to FIG. 2 and FIG. 3. The electronic device 100a further includes the inner metal member 150 located in the casing 110. The metal retaining wall 140 is formed by folding a part of the inner metal member 150. The inner metal member 150 includes an opening 151 located next to the metal retaining wall 140. The antenna 120 is located on one side of the metal retaining wall 140 opposite to the opening 151.

It should be noted that in the embodiment, the metal retaining wall 140 and the inner metal member 150 are integrally formed, and the structure of the metal retaining wall 140 is formed by cutting a part of the inner metal member 150 through computer numerical control (CNC) and then folding the part by 90 degrees. However, in other embodiments, the metal retaining wall 140 may also be a separate plate member connected to the inner metal member 150 through welding. The disclosure does not limit the connection manner between the metal retaining wall 140 and the inner metal member 150 and the angle between the metal retaining wall 140 and the inner metal member 150.

Please continue to refer to FIG. 2 and FIG. 3. A length L5 (FIG. 2) of the metal retaining wall 140 is between 0.2 times and 0.3 times the wavelength of the frequency band in which the antenna 120 resonates. A distance D1 between the metal retaining wall 140 and the antenna 120 is between 0.05 times and 0.15 times the wavelength of the frequency band. A height H1 (FIG. 3) of the metal retaining wall 140 is between 0.05 times and 0.15 times the wavelength of the frequency band.

For example, in the embodiment, the antenna 120 is a Wi-Fi 6E antenna, and the frequency band in which the antenna 120 resonates is 2400 to 2500 MHZ. Therefore, in the embodiment, the length L5 of the metal retaining wall 140 may be 30 mm, the distance D1 between the metal retaining wall 140 and the antenna 120 may be 15 mm, and the height H1 of the metal retaining wall 140 may be 10 mm, but the length L5 and the height H1 of the metal retaining wall 140 and the distance D1 from the antenna 120 are not limited thereto.

In addition, in other embodiments, when the antenna 120 is a WWAN 5G Sub 6 antenna, the frequency band in which the antenna 120 resonates is 617 to 960 MHZ, the length L5 of the metal retaining wall 140 may be 90 mm, and the height H1 of the metal retaining wall 140 may be 10 mm, but the length L5 and the height H1 of the metal retaining wall 140 are also not limited thereto.

It is worth mentioning that in the electronic device 100a, the length L5 (FIG. 2) of the metal retaining wall 140 is between 0.2 times and 0.3 times the wavelength of the frequency band, the distance D1 between the metal retaining wall 140 and the antenna 120 is between 0.05 times and 0.15 times the wavelength of the frequency band, and the height H1 (FIG. 3) of the metal retaining wall 140 is between 0.05 times and 0.15 times the wavelength of the frequency band to suppress the signal interference of the antenna 120 caused by the noise of the connector 130.

On the other hand, in the embodiment, the number of the metal retaining walls 140 is two, and the metal retaining walls 140 are respectively disposed next to the main antenna 121 and the auxiliary antenna 122, but the number of the metal retaining walls 140 is not limited thereto. In other embodiments, the number of the metal retaining wall 140 may also be one, and the main antenna 121 and the auxiliary antenna 122 share the same metal retaining wall 140, which is not limited in the disclosure.

It is worth mentioning that in the electronic device 100a, in addition to disposing the first slot 112 and the second slot 113 on the metal layer 111 to reduce the interference of the antenna 120 caused by the noise of the connector 130, the metal retaining wall 140 is further disposed next to the antenna 120 to reduce the impact of high-frequency interference noise received by the antenna 120 on the wireless reception performance of the electronic device 100a, thereby improving the wireless reception performance of the electronic device 100a. On the other hand, the opening 151 of the electronic device 100a may change a conduction interference current path located in the inner metal member 150, thereby reducing the probability of a noise interference source coupling energy to the antenna 120 through a system ground plane.

In addition, in the electronic device 100a, by arranging the first slot 112, the second slot 113, and the metal retaining wall 140, the electronic device 100a not only has the above-mentioned noise suppression effect, but also the overall stability and flexibility of the electronic device 100a are improved.

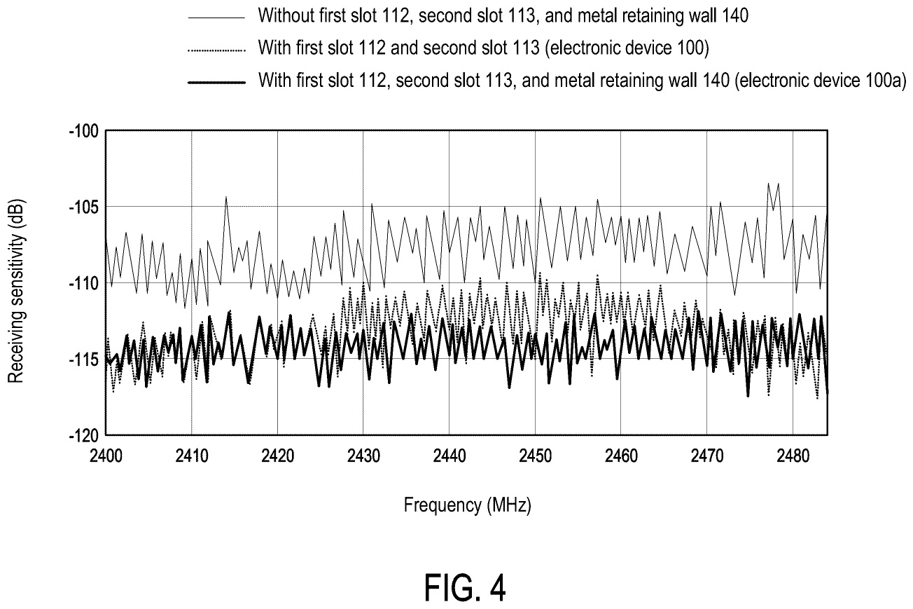

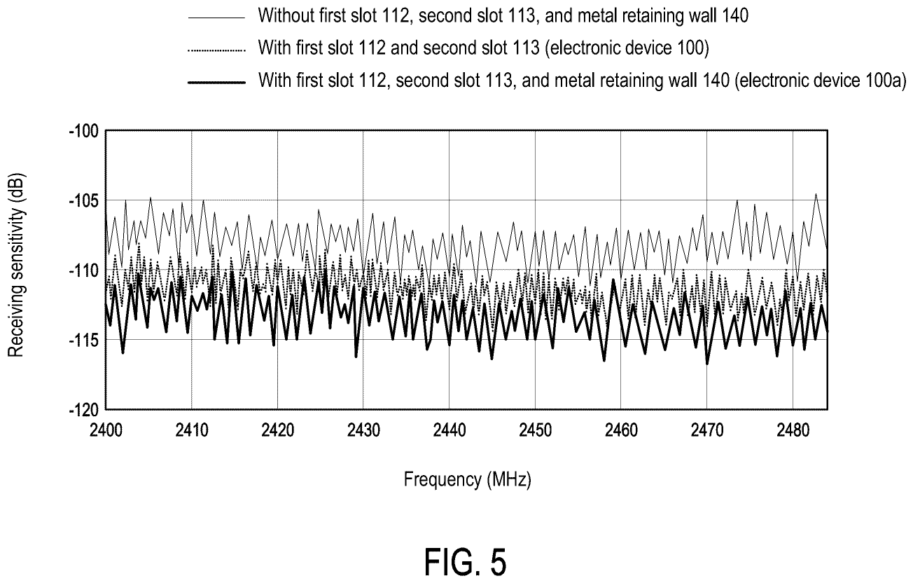

FIG. 4 is a frequency-receiving sensitivity relationship diagram of a main antenna of the electronic device of FIG. 1A and FIG. 2. FIG. 5 is a frequency-receiving sensitivity relationship diagram of an auxiliary antenna of the electronic device of FIG. 1A and FIG. 2. It should be noted that in order to clearly illustrate the effect of improving the receiving sensitivities of the electronic devices 100 and 100a, data of the receiving sensitivities of FIG. 4 and FIG. 5 is simplified.

In addition, it should be noted that in FIG. 4 and FIG. 5, the receiving sensitivities of a conventional device, the electronic device 100, and the electronic device 100a are compared, wherein the conventional device does not have the first slot 112, the second slot 113, and the metal retaining wall 140, the electronic device 100 has the first slot 112 and the second slot 113, and the electronic device 100a has the first slot 112, the second slot 113, and the metal retaining wall 140.

Please refer to FIG. 4 and FIG. 5. When the antenna 120 of the electronic devices 100 and 100a is the Wi-Fi 6E antenna, that is, the frequency band in which the antenna 120 resonates is 2400 to 2500 MHZ, and the connector 130 accesses the external storage device 10, compared with the conventional device, the receiving sensitivity of the main antenna 121 of the electronic devices 100 and 100a can be improved by 3 to 5 dB as shown in FIG. 4, and the receiving sensitivity of the auxiliary antenna 122 can be improved by more than 5 dB as shown in FIG. 5.

In other words, in the electronic devices 100 and 100a, the impact of access noise of the connector 130 on the antenna 120 can be reduced, and the noise interference suppression abilities of the electronic devices 100 and 100a can both be above 3 dB. Such a design enables the antenna 120 of the electronic devices 100 and 100a to have a good shielding effect, thereby enabling the antenna 120 to have good wireless communication quality.

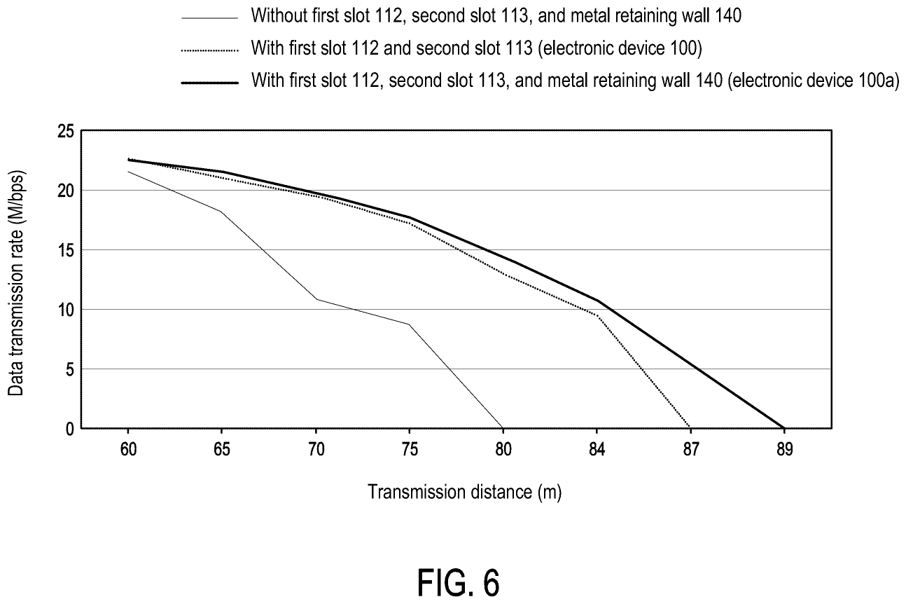

FIG. 6 is a transmission distance-data transmission rate relationship diagram of the electronic device of FIG. 1A and FIG. 2. Please refer to FIG. 6. Under the condition of the same transmission distance, compared with the conventional device, the data transmission rate of the antenna 120 of the electronic devices 100 and 100a can be improved by 5 to 10 M/bps. In addition, when the transmission distance is longer, that is, when signal attenuation is higher, the antenna 120 of the electronic devices 100 and 100a can also have a good performance. In other words, in the electronic devices 100 and 100a, the receiving sensitivity of the antenna 120 can be improved, thereby improving the performance of wireless communication transmission.

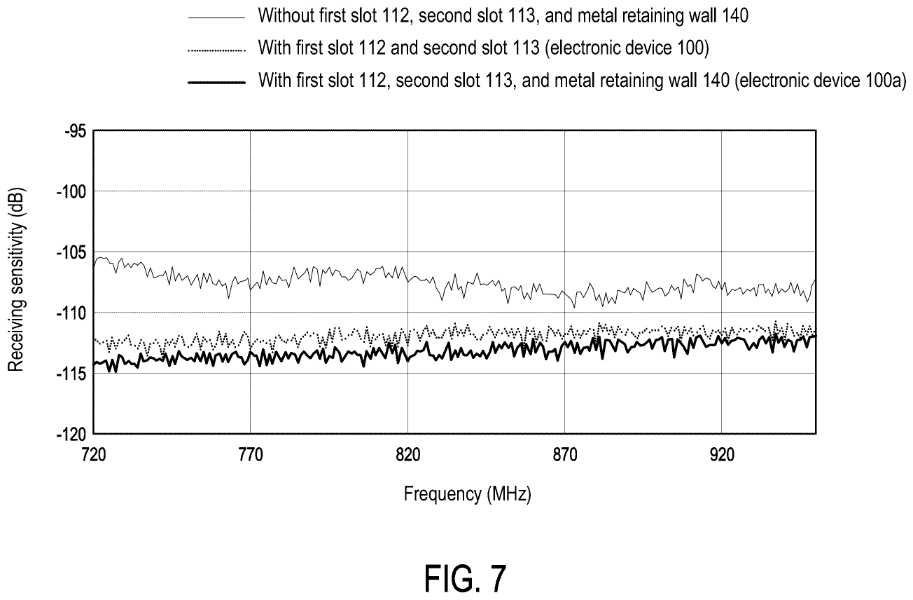

FIG. 7 is a frequency-receiving sensitivity relationship diagram of the electronic device of FIG. 1A and FIG. 2. When the antenna 120 of the electronic devices 100 and 100a is a WWAN 5G Sub 6 FR1 antenna, that is, the frequency band in which the antenna 120 resonates is 720 to 960 MHz, and the connector 130 accesses the external storage device 10, compared with the conventional device, the receiving sensitivity of the antenna 120 of the electronic devices 100 and 100a can be improved by 6 to 8 dB. In other words, in the electronic devices 100 and 100a, the impact of access noise of the connector 130 on the antenna 120 can be reduced, and the noise interference suppression abilities of the electronic devices 100 and 100a can both be above 6 dB. Such a design enables the antenna 120 of the electronic devices 100 and 100a to have a good shielding effect, thereby enabling the antenna 120 to have good wireless communication quality.

In summary, in the electronic device of the disclosure, the antenna is connected to the first region and the connector is connected to the second region to reduce the interference of the antenna caused by the noise of the connector, thereby improving the transmission distance and the wireless communication quality. In addition, the electronic device may also include the metal retaining wall disposed next to the antenna to reduce the impact of high-frequency interference noise received by the antenna on the wireless reception performance of the electronic device. Such a design not only enables the electronic device to suppress noise, but also improves the overall stability and flexibility of the electronic device.

What is claimed is:

1. An electronic device, comprising:
a casing, comprising a metal layer and a first slot and a second slot located on the metal layer, wherein the metal layer comprises a metal connecting segment, a first region, and a second region, the metal connecting segment is located between the first slot and the second slot, and the first region and the second region are separated by the first slot, the second slot, and the metal connecting segment;
an antenna, connected to the first region and adapted to resonate at a frequency band; and
a connector, connected to the second region.

2. The electronic device according to claim 1, wherein a length of the metal connecting segment is between 0.2 times and 0.3 times a wavelength of the frequency band.

3. The electronic device according to claim 1, wherein a length of the first slot is between 1.5 times and 2 times a wavelength of the frequency band, and the first slot is L-shaped or arc-shaped.

4. The electronic device according to claim 1, wherein a length of the second slot is between 0.15 times and 0.25 times a wavelength of the frequency band.

5. The electronic device according to claim 1, wherein the casing further comprises a via located on the metal layer, and the via is connected to the first slot or the second slot.

6. The electronic device according to claim 1, further comprising a metal retaining wall located next to the antenna, wherein a length of the metal retaining wall is between 0.2 times and 0.3 times a wavelength of the frequency band.

7. The electronic device according to claim 6, wherein a distance between the metal retaining wall and the antenna is between 0.05 times and 0.15 times the wavelength of the frequency band.

8. The electronic device according to claim 6, wherein a height of the metal retaining wall is between 0.05 times and 0.15 times the wavelength of the frequency band.

9. The electronic device according to claim 6, further comprising an inner metal member located in the casing, wherein the metal retaining wall is formed by folding a part of the inner metal member, the inner metal member comprises an opening located next to the metal retaining wall, and the antenna is located on one side of the metal retaining wall opposite to the opening.

10. The electronic device according to claim 1, wherein the frequency band is between 617 MHz and 960 MHz or between 2400 MHz and 2500 MHz.
